(19) United States
(12) Patent Application Publication
(10) Pub. No.: US 2026/0005471 A1
(43) Pub. Date: Jan. 1, 2026

(54) High Voltage Electrical Connector

(71) Applicant: Lear Corporation, Southfield, MI (US)

(72) Inventors: Li Jin, Shanghai (CN); Huang Youwei, Shanghai (CN); Fang Chao, Shanghai (CN)

(73) Assignee: Lear Corporation, Southfield, MI (US)

(21) Appl. No.: 19/249,289

(22) Filed: Jun. 25, 2025

(30) Foreign Application Priority Data
Jun. 26, 2024 (CN) 202410841004.6

(51) Int. Cl. H01R 13/629; H01R 13/04; H01R 13/436; H01R 13/502

(52) U.S. Cl. CPC H01R 13/62938; H01R 13/04; H01R 13/4364; H01R 13/502

(57) ABSTRACT

An electrical connector includes an inner housing. The inner housing defines a terminal cavity that is adapted to accommodate an electrical terminal. A terminal position assurance is attached to the inner housing for relative movement between an open position and a closed position. The terminal position assurance extends into the terminal cavity when in the closed position. The electrical connector includes an outer housing with an outer body that defines an outer housing cavity. The outer body also defines an outer housing opening. The inner housing is retained in the outer housing cavity. A lever is connected to the outer housing for relative movement between a pre-mate position and a mated position. The lever defines a lever opening. The outer housing opening is located between the terminal position assurance and the lever opening.

### FIELD

This disclosure relates to an electrical connector. More specifically, this disclosure relates to an improved high voltage electrical connector.

### BACKGROUND

Electrical components are often connected to each other using conductive cables, and electrical connectors attached to the cables allow the components to be connected at a desired time. For example, electrical components from different sources can be brought together during the manufacture of a larger assembly. It is desirable to provide an improved electrical connector that allows components to be connected accurately and easily.

### SUMMARY

Various example electrical connectors are described.

An example electrical connector includes an inner housing. The inner housing defines a terminal cavity that is adapted to accommodate an electrical terminal. A terminal position assurance is attached to the inner housing for relative movement between an open position and a closed position. The terminal position assurance extends into the terminal cavity when in the closed position. The electrical connector includes an outer housing with an outer body that defines an outer housing cavity. The outer body also defines an outer housing opening. The inner housing is retained in the outer housing cavity. A lever is connected to the outer housing for relative movement between a pre-mate position and a mated position. The lever defines a lever opening. The outer housing opening is located between the terminal position assurance and the lever opening.

Another example electrical connector includes a connector housing. The connector housing has a body that defines a housing cavity. The housing cavity defines a housing cavity axis. A connector position assurance is attached to the connector housing for relative movement between a pre-lock position and a locked position. The connector position assurance includes a connector position assurance body and a leg that extends from the connector position assurance body. The leg is movable relative to the connector position assurance body between a stop position and a release position. The leg includes a trigger that engages the connector housing to retain the connector position assurance in the pre-lock position when the leg is in the stop position. The trigger is located a first distance from the housing cavity axis. The connector position assurance body is located a second distance from the housing cavity axis that is greater than the first distance.

Another example electrical connector includes a housing that defines a terminal cavity. The terminal cavity extends between a contact end and a connection end. An electrical terminal is located in the terminal cavity. The electrical terminal includes a contact portion that is adapted to engage a corresponding terminal and a connection portion that is adapted to engage a conductor. The contact portion is located nearer the contact end of the terminal cavity than the connection end. The connection portion is located nearer the connection end of the terminal cavity than the contact end. The electrical terminal includes a tab on the contact portion that extends toward the connection end of the terminal cavity. A terminal position assurance is attached to the housing and engages the tab to retain the electrical terminal in the terminal cavity.

Additional understanding of these examples will become apparent to those skilled in the art from the following detailed description, when read in light of the accompanying drawings.

### BRIEF DESCRIPTION OF THE DRAWINGS

FIG. 1 is a perspective view of an example electrical connector assembly that includes a first electrical connector and a second electrical connector.

FIG. 2 is a perspective view of the first electrical connector illustrated in FIG. 1.

FIG. 3 is a rear perspective view of the first electrical connector illustrated in FIG. 2.

FIG. 4 is an enlarged rear perspective view of an inner housing from the first electrical connector illustrated in FIG. 3.

FIG. 5 is a cross-sectional view taken along line 5-5 in FIG. 3.

FIG. 6 is a cross-sectional view taken along line 6-6 in FIG. 5.

FIG. 7 is a cross-sectional view similar to FIG. 6 showing a terminal position assurance moved to a closed position.

FIG. 8 is an enlarged view of a connector position assurance from the first electrical connector illustrated in FIG. 2.

FIG. 9 is an enlarged cross-sectional view of a portion of FIG. 5, with a lever shown in a closed position and the connector position assurance in a locked position.

FIG. 10 is a perspective view of the second electrical connector illustrated in FIG. 1.

FIG. 11 is a partially exploded view of the second electrical connector illustrated in FIG. 10.

FIG. 12 is a cross-sectional view taken along the line 12-12 in FIG. 10.

FIG. 13 is a cross-sectional view taken along the line 13-13 in FIG. 12.

FIG. 14 is a cross-sectional view taken along the line 14-14 in FIG. 6.

FIG. 15 is an enlarged perspective view of a cable retainer from the first electrical connector illustrated in FIG. 2.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first shield could be termed a second shield, and, similarly, a second shield could be termed a first shield, without departing from the scope of the various described embodiments. The first shield and the second shield are both shields, but they are not the same shield.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

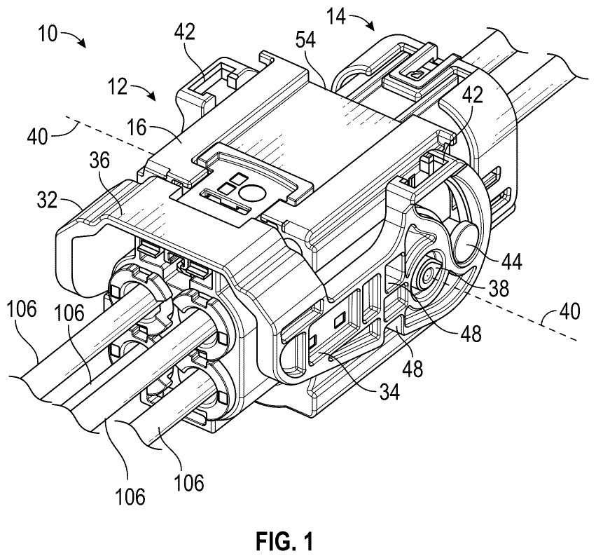

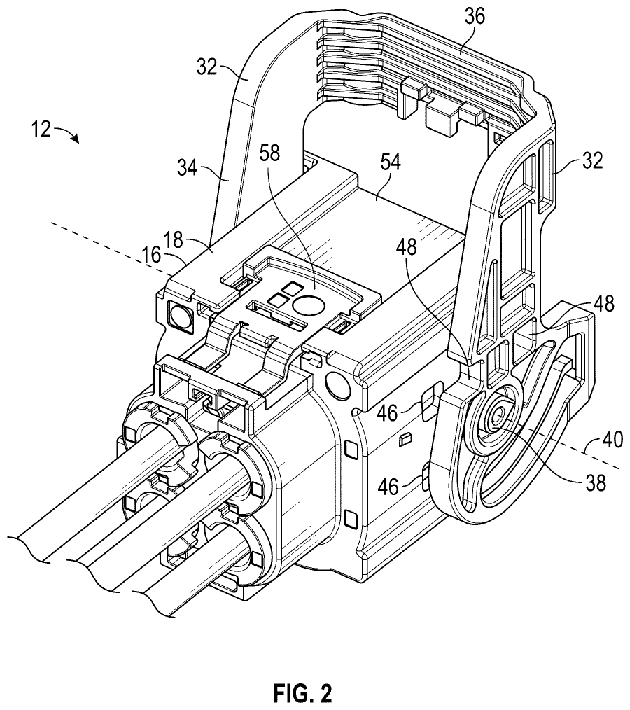

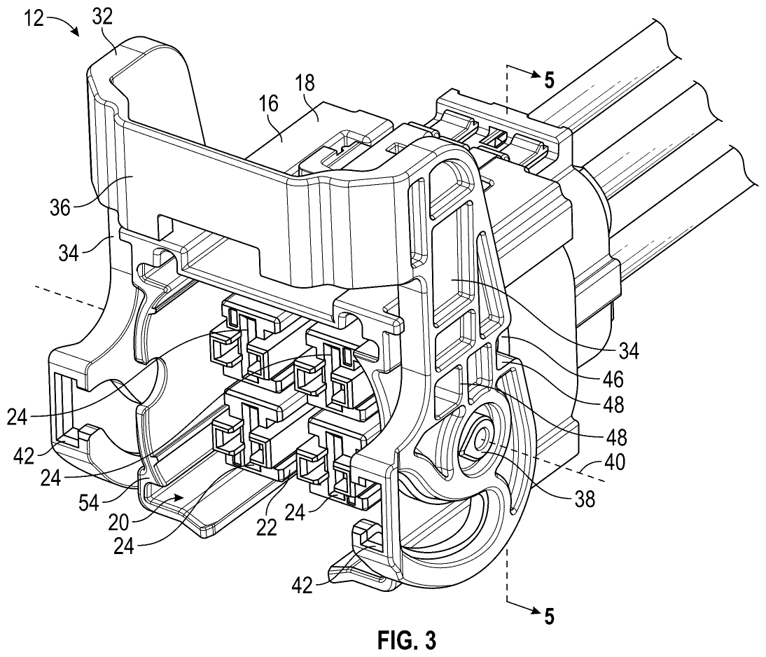

Referring now to the drawings there is illustrated in FIG. 1 a front perspective view of an electrical connector assembly, indicated generally at 10. The electrical connector assembly 10 includes a first electrical connector, indicated generally at 12 and a second electrical connector, indicated generally at 14. The first electrical connector 12 is shown mated with the second electrical connector 14 in FIG. 1. Referring to FIG. 2, there is illustrated a front perspective view of the first electrical connector 12 and FIG. 3 illustrates a rear perspective view of the first electrical connector. 12.

The first electrical connector 12 includes an outer housing 16. The illustrated outer housing 16 is molded from plastic but may be made of any desired material and by any desired process. The outer housing 16 includes an outer housing body 18 that defines an outer housing cavity, indicated generally at 20.

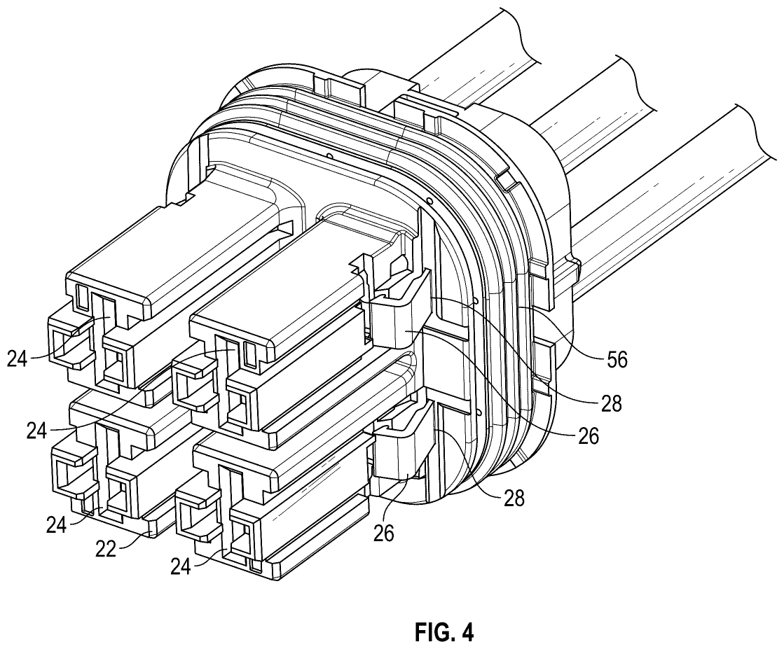

The first electrical connector 12 includes an inner housing 22. The illustrated inner housing 22 is molded from plastic but may be made of any desired material and by any desired process. FIG. 4 illustrates a rear perspective view of the inner housing 22. The inner housing 22 defines a terminal cavity 24 that is adapted to accommodate an electrical terminal (not shown). The illustrated inner housing 22 includes four terminal cavities 24, but may have any desired number of terminal cavities 24. The inner housing 22 also includes a terminal position assurance 26. The terminal position assurance 26 is shown in FIG. 4 attached to the inner housing 22 and in an open position. The illustrated terminal position assurance 26 is molded as part of the inner housing 22 and includes a living hinge 28. Two terminal position assurances 26 are visible in FIG. 4, and in the illustrated embodiment each terminal cavity 24 includes a terminal position assurance 26.

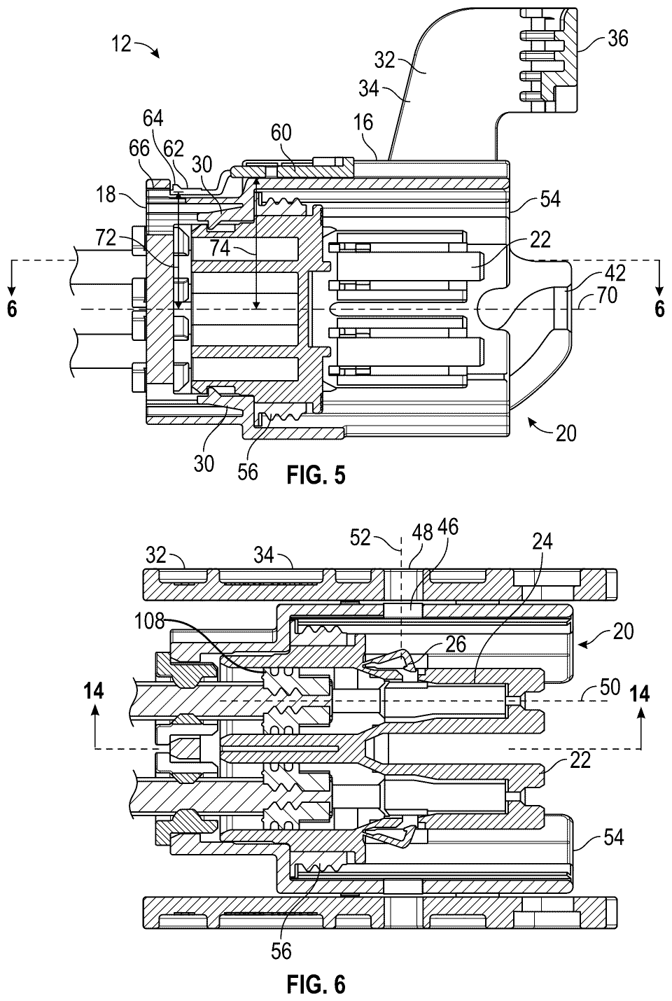

FIG. 5 is a cross-sectional view taken along the line 5-5 in FIG. 3. The outer housing 16 includes an inner latch 30 which engages the inner housing 22 and the inner housing 22 is retained in the outer housing cavity 20. Referring to FIG. 6, a cross-sectional view taken along the line 6-6 in FIG. 5 is illustrated. As shown, the terminal position assurance 26 is in the open position when the inner housing 22 is attached to the outer housing 16.

The first electrical connector 12 includes a lever 32 that is attached to the outer housing 16 for relative movement (e.g., relative rotational movement) between a pre-mate position shown in FIGS. 2 and 3, and a mated position shown in FIG. 1. The lever 32 engaging the leg 62, as described in more detail herein, in the mated position and displacing the leg in the release position. The lever 32 includes two lever arms 34 that are joined by a handle 36. The illustrated lever 32 is supported on two posts 38 on the outer housing 16, and the illustrated lever 32 is rotatable relative to the outer housing 16 about a lever axis 40. The lever 32 includes two channels 42, one defined in each arm 34. The second electrical connector 14 includes two lugs 44, one is shown in FIG. 1. In order to mate the first electrical connector 12 with the second electrical connector 14, the lever 32 is moved to the open position and the second electrical connector 14 is positioned so that each of the lugs 44 on the second electrical connector 14 is located in one of the channels 42. The lever 32 is then moved to the closed position in order to pull the second electrical connector 14 into engagement with the first electrical connector 12.

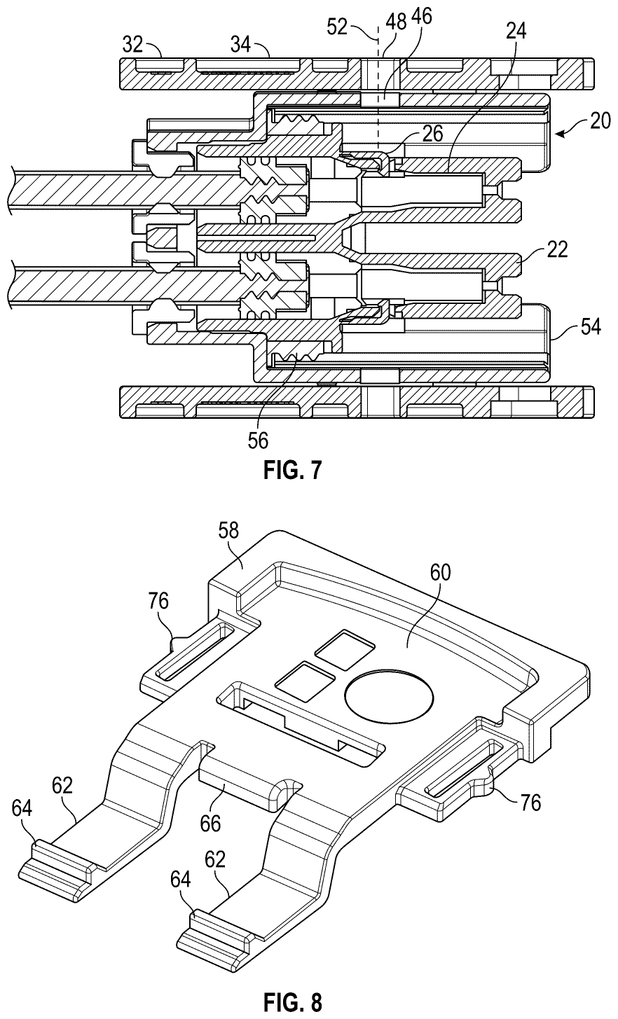

Referring back to FIG. 6, the lever 32 is shown in the mated position. The outer housing 16 defines an outer housing opening 46 that extends through the outer housing body 18 into the outer housing cavity 20. Additionally, the lever 32 defines a lever opening 48 that extends therethrough. The illustrated lever opening 48 is defined through one of the lever arms 34, but may be on any desired part of the lever 32. When the lever 32 is in the mated position, the outer housing opening 46 is located between the terminal position assurance 26 and the lever opening 48. The terminal position assurance 26 is movable relative to the terminal cavity 24 from the open position shown in FIG. 6 to a closed position shown in FIG. 7. When the terminal position assurance 26 is in the closed position, the terminal position assurance 26 extends into the terminal cavity 24 and is adapted to act as a primary lock for the electrical terminal (not shown) located in the terminal cavity 24. The outer housing opening 46 and the lever opening 48 provide access to the terminal position assurance 26 to allow an operator to insert a tool to move the terminal position assurance 26 to the closed position.

As shown in FIG. 6, the terminal cavity 24 extends through the inner housing 22 and defines a terminal cavity axis 50. Additionally, an imaginary insert axis 52 extends from the terminal position assurance 26, through the outer housing opening 46, and through the lever opening 48. In the illustrated embodiment, the insert axis 52 is perpendicular to the terminal cavity axis 50.

The outer housing cavity 20 includes a mating opening 54 at an outer end. The mating opening 54 accommodates a corresponding electrical connector, such as the second electrical connector 14 when the first electrical connector 12 and the second electrical connector 14 are mated. As best shown in FIG. 4, the first electrical connector 12 includes a cavity seal 56 on the inner housing 22. As shown in FIG. 6, the cavity seal 56 is located in the outer housing cavity 20. The outer housing opening 46 is located between the mating opening 54 and the cavity seal 56.

Referring back to FIG. 2, the first electrical connector 12 includes a connector position assurance 58. The connector position assurance 58 is attached to the outer housing 16 for relative movement between a pre-lock position shown in FIG. 2, and a locked position shown in FIG. 1. An enlarged perspective view of the connector position assurance 58 is illustrated in FIG. 8. The illustrated connector position assurance 58 is molded from plastic but may be made of any desired material and by any desired process.

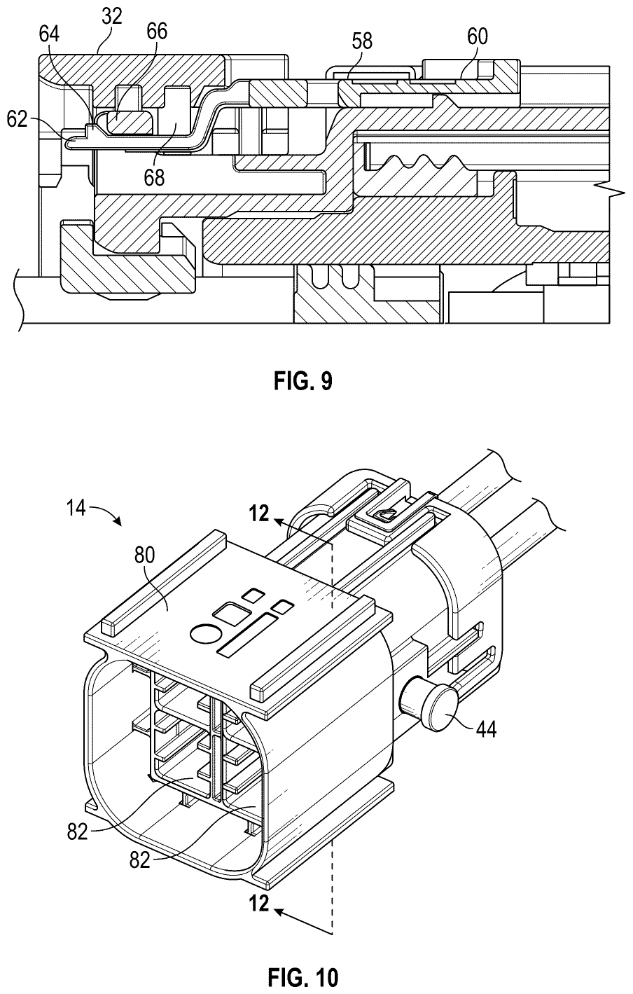

The connector position assurance 58 includes a connector position assurance body 60. A leg 62 extends from the connector position assurance body 60. The leg 62 is movable relative to the connector position assurance body 60 between a stop position and a release position. The leg 62 is shown in the stop position in FIG. 5. In the stop position, a trigger 64 the leg 62 engages a catch 66 on the outer housing 16 to prevent the connector position assurance 58 from being moved to the locked position. FIG. 9 is an enlarged cross-sectional view similar to FIG. 5, with the lever 32 shown in the closed position and the connector position assurance 58 shown in the locked position. The lever 32 includes a release that engages the leg 62 and moves the leg 62 relative to the outer housing 16 to the release position. This allows the connector position assurance 58 to be moved to the lock position. The connector position assurance 58 includes a block 68 that engages a portion of the lever 32 when the lever 32 is in the closed position and the connector position assurance 58 is in the locked position. The connector position assurance 58 thereby retains the lever 32 in the closed position.

Referring back to FIG. 5, the outer housing cavity 20 extends through the outer housing body 18 and defines a housing cavity axis 70. The trigger 64 is located a first distance 72 from the housing cavity axis 70, the connector position assurance body 60 is located a second distance 74 from the housing cavity axis 70, and the second distance is greater than the first distance.

Referring back to FIG. 8, the connector position assurance 58 includes a connector position assurance lock 76. The connector position assurance lock 76 engages the outer housing body 18 to hold the connector position assurance 58 in the pre-lock position relative to the outer housing body 18. The illustrated connector position assurance lock 76 is attached to the connector position assurance body 60, and the connector position assurance lock 76 is located the second distance 74 from the housing cavity axis 70.

As shown in FIG. 8, the illustrated connector position assurance 58 includes two legs 62, and each leg 62 includes a trigger 64. Each of the legs 62 has a similar shape, and each trigger 64 is located the first distance 72 from the housing cavity axis 70.

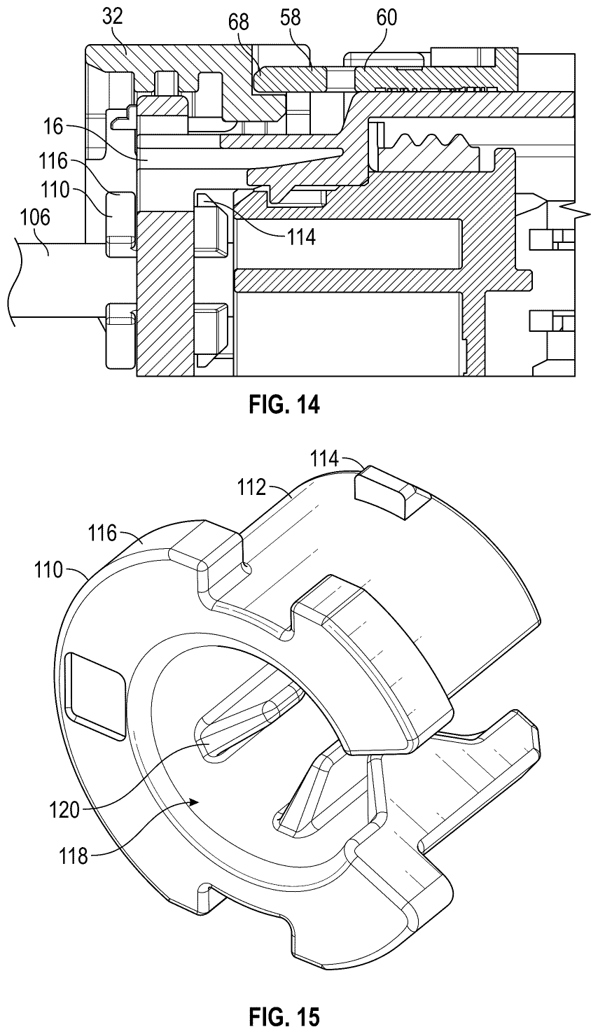

As shown in FIGS. 5 and 9, the connector position assurance 58 is movable relative to the outer housing 16 parallel to the housing cavity axis 70 between the pre-lock position and the locked position. Referring to FIG. 14, there is illustrated a cross-sectional view taken through the connector position assurance 58 in the locked position. As previously described, the block 68 on the connector position assurance 58 engages the lever 32 to retain the lever 32 in the closed position. The connector position assurance 58 thereby prevents the lever 32 from being inadvertently moved from the closed position by, for example, vibration conditions experienced by the electrical connector assembly 10.

As previously described, the illustrated inner housing 22 includes four terminal cavities 24. Referring back to FIG. 1, the illustrated first electrical connector 12 is attached to four cables 106, and each of the cables 106 extends into a respective one of the terminal cavities 24. Referring to FIG. 6, each terminal cavity 24 includes a respective cable seal 108 that is located between the respective cable 106 and the inner housing 22. The illustrated first electrical connector 12 also includes a cable retainer 110 that is located between the cable 106 and the outer housing body 18.

Referring to FIG. 15, an enlarged perspective view of the cable retainer 110 is illustrated. The cable retainer 110 includes a C-shaped retainer body 112. An inner catch 114 and an outer catch 116 extend outwardly from the retainer body 112. The retainer body 112 defines a retainer cavity, indicated generally at 118, that extends therethrough. A plurality of retainer fins 120 extend from the retainer body 112 inwardly into the retainer cavity 118. As best shown in FIG. 14, the inner catch 114 and the outer catch 116 engage the outer housing body 18 to hold the cable retainer 110 in position relative to the outer housing 16. The cable 106 extends through the retainer cavity 118, and the plurality of retainer fins 120 engage the cable 106 to hold the cable 106 in place relative to the first electrical connector 12. This prevents the cable seal 108 from being moved relative to the inner housing 22 by force applied to the cable 106. As shown in FIG. 1, the illustrated first electrical connector 12 includes four cable retainers 110, one for each cable 106.

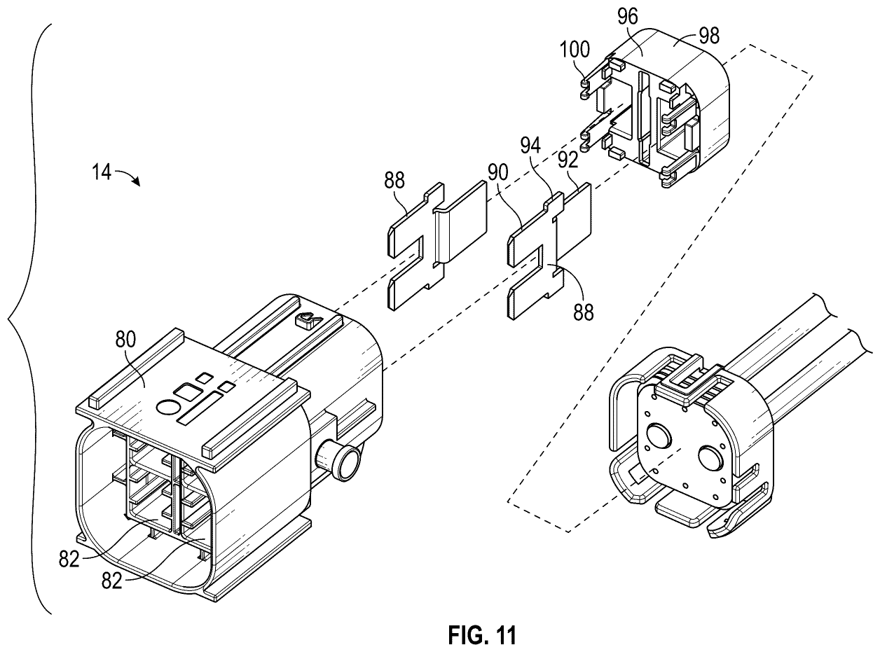

Referring now to FIG. 10, there is illustrated a perspective view of the second electrical connector 14, and FIG. 11 is a partially exploded view of the second electrical connector 14. The second electrical connector 14 includes a second housing 80. The illustrated second housing 80 is molded from plastic but may be made of any desired material and by any desired process. The second housing 80 defines a second terminal cavity 82. The second terminal cavity 82 extend through the second housing 80 between a contact end 84 and a connection end 86.

A second electrical terminal 88 is located in the second terminal cavity 82. The second electrical terminal 88 includes a contact portion 90 that is adapted to engage the electrical terminal in the first electrical connector 12, and a connection portion 92 that is adapted to engage a conductor (not shown) of a cable 93. The contact portion 90 is located nearer the contact end 84 of the second terminal cavity 82 than the connection end 86 and the connection portion 92 is located nearer the connection end 86 of the second terminal cavity 82 than the contact end 84. The second electrical terminal 88 includes a tab 94 on the contact portion 90 that extends towards the connection end 86 of the second terminal cavity 82.

The second electrical connector 14 includes a second terminal position assurance 96. The illustrated second terminal position assurance 96 is molded from plastic but may be made of any desired material and by any desired process. The second terminal position assurance 96 includes a terminal position assurance body 98. A terminal position assurance lock 100 extends from the terminal position assurance body 98.

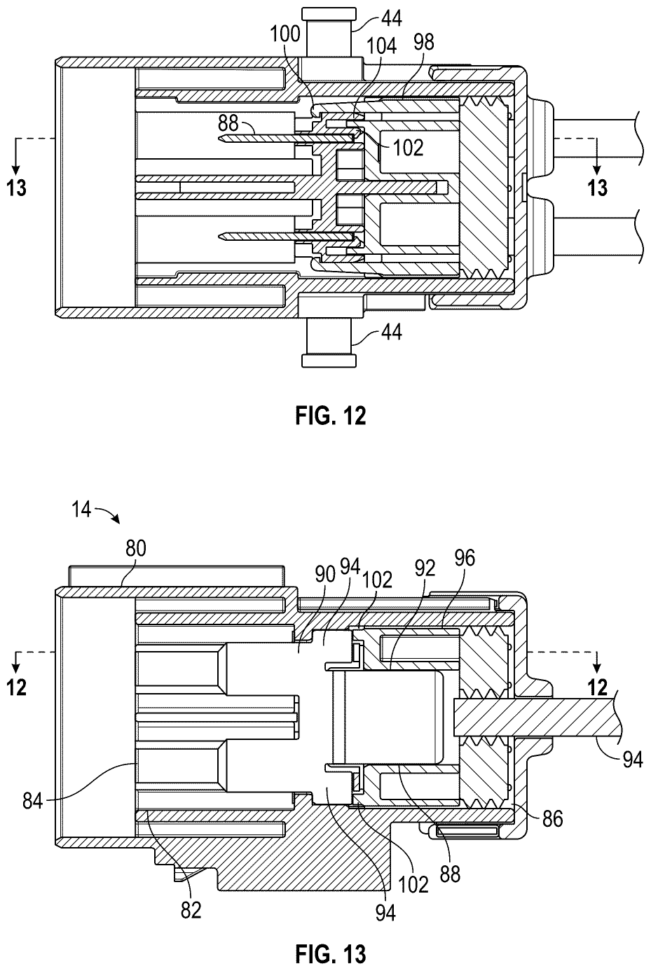

FIG. 12 is a cross-sectional view taken along the line 12-12 in FIG. 10. As shown, the terminal position assurance lock 100 engages the second housing 80 to retain the second terminal position assurance 96 in the second housing 80. The second housing 80 includes a terminal latch 102 that engages the second electrical terminal 88 to retain the second electrical terminal 88 in the second terminal cavity 82. The second terminal position assurance 96 includes a lock reinforcement 104 that is located behind the terminal latch 102 in order to retain the terminal lock in a terminal locked position, as opposed to a terminal released position, to prevent the terminal latch 102 from releasing the second electrical terminal 88. Referring back to FIG. 12, a stop 103 on the second terminal position assurance 96 engages the tab 94 on the second electrical terminal 88 in order to retain the second electrical terminal 88 in the second terminal cavity 82.

Referring back to FIG. 11, the illustrated second electrical terminal 88 is a male blade terminal, and the tab 94 extends from the male blade. Additionally, the illustrated second electrical terminal 88 includes a split contact portion 90 and is adapted to engage two electrical terminals located in the first electrical connector 12. However, the second electrical terminal 88 may be any desired type of terminal. The illustrated tab 94 is a first tab 94 that is located on a first side of the contact portion 90. The second electrical terminal 88 includes a second tab 94 that is located on a second side of the contact portion 90 and which extends toward the connection end of the terminal cavity. The second side of the contact portion 90 is opposite the first side of the contact portion 90. The illustrated second electrical connector 14 includes two second electrical terminals 88. However, the second electrical connector 14 may include any desired number of second electrical terminals 88.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

1. An electrical connector comprising:
an inner housing defining a terminal cavity adapted to accommodate an electrical terminal;
a terminal position assurance attached to the inner housing for relative movement between an open position and a closed position, the terminal position assurance extending into the terminal cavity when in the closed position;
an outer housing including an outer body that defines an outer housing cavity and an outer housing opening, the inner housing retained in the outer housing cavity;
a lever connected to the outer housing for relative movement between a pre-mate position and a mated position, the lever defining a lever opening; and
wherein the outer housing opening is located between the terminal position assurance and the lever opening.

2. The electrical connector of claim 1, wherein the outer housing opening is located between the terminal position assurance and the lever opening when the lever is in the mated position.

3. The electrical connector of claim 2, wherein the terminal cavity defines a terminal cavity axis, wherein an insert axis extends through the outer housing opening and the lever opening when the lever is in the mated position, and wherein the insert axis is perpendicular to the terminal cavity axis.

4. The electrical connector of claim 1, wherein the lever is connected to the outer housing for relative rotational movement between the pre-mate position and the mated position.

5. The electrical connector of claim 1, wherein the outer housing opening and the lever opening are adapted to allow a tool to be inserted therethrough to engage the terminal position assurance when the lever is in the mated position.

6. The electrical connector of claim 1, wherein the outer housing cavity includes a mating opening at a first end that is adapted to accommodate a corresponding electrical connector;
further comprising a cavity seal located in the outer housing cavity, the cavity seal adapted to engage the corresponding electrical connector; and
wherein the outer housing opening is located between the mating opening and the cavity seal.

7. The electrical connector of claim 1, wherein the terminal position assurance is adapted to act as a primary lock to retain the electrical terminal in the terminal cavity.

8. The electrical connector of claim 1, wherein the terminal position assurance is molded as part of the inner housing.

9. An electrical connector comprising;
a connector housing including a body that defines a housing cavity that defines a housing cavity axis; and
a connector position assurance attached to the connector housing for relative movement between a pre-lock position and a locked position, the connector position assurance including a connector position assurance body and a leg that extends from the connector position assurance body, the leg movable relative to the connector position assurance body between a stop position and a release position and including a trigger that engages the connector housing to retain the connector position assurance in the pre-lock position when the leg is in the stop position, the trigger is located a first distance from the housing cavity axis, the connector position assurance body is located a second distance from the housing cavity axis that is greater than the first distance.

10. The electrical connector of claim 9, wherein the connector position assurance includes a connector position assurance lock that engages the connector housing to hold the connector position assurance in the pre-lock position relative to the connector housing; and
wherein the connector position assurance lock is located the second distance from the housing cavity axis.

11. The electrical connector of claim 9, wherein the leg is a first leg and the trigger is a first trigger, and the connector position assurance includes a second leg that extends from the connector position assurance body, the second leg movable relative to the connector position assurance body between a stop position and a release position and including a second trigger that engages the connector housing to retain the connector position assurance in the pre-lock position when the second leg is in the stop position, the second trigger is located the first distance from the housing cavity axis.

12. The electrical connector of claim 9, further comprising a lever attached to the connector housing for relative movement between a pre-mate position and a mated position, the lever engaging the leg in the mated position and displacing the leg to the release position.

13. The electrical connector of claim 9, wherein the connector position assurance is movable relative to the connector housing parallel to the housing cavity axis between the pre-lock position and the locked position.

14. An electrical connector comprising:
a housing defining a terminal cavity that extends between a contact end and a connection end;
an electrical terminal located in the terminal cavity, the electrical terminal including a contact portion that is adapted to engage a corresponding terminal and a connection portion that is adapted to engage a conductor, the contact portion is located nearer the contact end of the terminal cavity than the connection end and the connection portion is located nearer the connection end of the terminal cavity than the contact end, the electrical terminal including a tab on the contact portion that extends toward the connection end of the terminal cavity; and
a terminal position assurance attached to the housing and engaging the tab to retain the electrical terminal in the terminal cavity.

15. The electrical connector of claim 14, wherein the contact portion of electrical terminal is a male blade and the tab extends from the male blade.

16. The electrical connector of claim 14, wherein the tab is a first tab that is located on a first side of the contact portion, and the electrical terminal including a second tab on a second side of the contact portion that extends toward the connection end of the terminal cavity.

17. The electrical connector of claim 16, wherein the second side of the contact portion is opposite the first side of the contact portion.

18. The electrical connector of claim 14, wherein the housing includes a terminal lock movable between a terminal locked position and a terminal released position, the terminal lock engaging the electrical terminal to retain the electrical terminal in the terminal cavity when in the terminal locked position.

19. The electrical connector of claim 18, the terminal position assurance engaging the terminal lock to retain the terminal lock in the terminal locked position.
